(19) United States
(12) Patent Application Publication
(10) Pub. No.: US 2010/0146556 A1
(43) Pub. Date: Jun. 10, 2010

(54) METHOD FOR OUTPUTTING CHANNEL LIST AND SYSTEM ENABLING OF THE METHOD

(76) Inventor: Kyung Dug Hong, Gyeongsangbuk-do (KR)

Correspondence Address: KED & ASSOCIATES, LLP, P.O. Box 221200, Chantilly, VA, 20153-1200, US

(21) Appl. No.: 12/516,073

(22) PCT Filed: Nov. 22, 2007
(86) PCT No.: PCT/KR07/05914

§ 371 Date: Jan. 5, 2010

(30) Foreign Application Priority Data
Nov. 23, 2006 (KR) 10-2006-0116511

(51) Int. Cl. H04N 5/445

(52) U.S. Cl. 725/56

(57) ABSTRACT

Disclosed herein is a channel list provision method and apparatus which, when providing a channel list including channel information (5201) inputted by the user, includes additional information, such as short names (5204) or service type information, in the channel list and provides the resulting channel list (5205), thereby enabling the user to select a desired channel more easily.

### TECHNICAL FIELD

The present invention relates to a method and apparatus for providing a channel list, and more particularly, to a channel list provision method and apparatus which, when providing a channel list including channel information inputted by the user, includes additional information, such as short names or service type information, in the channel list and provides the resulting channel list, thereby enabling the user to select a desired channel more easily.

### BACKGROUND ART

Conventionally, in order to change the channel of a video device using a remote controller, the user has to sequentially change the channel of the video device to a desired channel by inputting a channel up or down key of the remote controller (1) or immediately change the channel of the video device to the desired channel by personally inputting the number of the desired channel to the remote controller (2).

However, in the case of (1), there is a disadvantage that the user must press the channel up or down key to the desired channel, and, in the case of (2), there is a disadvantage that the user must know the number of the desired channel in advance.

Therefore, in order to improve these disadvantages, there has been conventionally proposed a method for searching for all channel numbers including channel information inputted by the user, creating and outputting a channel list including the searched channel numbers, and then enabling the user to make a change to a desired channel.

FIG. 1 illustrates a conventional example of configuring a channel list and providing the configured channel list to the user. Referring to FIG. 1, a conventional video device, when the user inputs channel information ‘1’ 101, outputs a channel list 102 including channel numbers having the channel information ‘1’ inputted by the user.

With the advance of video techniques, broadcasting stations may provide various types of channels in such a manner that a plurality of virtual channels may be included in one physical channel and different broadcast signals may be transmitted over the respective virtual channels. However, the conventional channel list does not additionally provide information related to the channel numbers, resulting in a problem that the user may feel difficulty in selecting a desired channel.

For example, where a channel number ‘DTV 11-11’ including the channel information ‘1’ is an ATSC digital television signal, a channel number ‘DTV 11-12’ is an ATSC audio signal and a channel number ‘DTV 11-14’ is an ATSC data only service signal, the conventional channel list does not additionally provide such information, so that the user is unable to select a desired channel with reference to such additional information.

Further, because the conventional channel list provides only channel numbers, in order to let the user to know a broadcast program of each channel, it is necessary to output the broadcast program of each channel or Electronic Program Guide (EPG) data of each channel. As a result, it is impossible for the user to rapidly and simply recognize the broadcast program of each channel.

Therefore, in order to solve the aforementioned conventional problems, there is a keen need for the development of a channel list provision method and apparatus to provide additional information related to channel numbers included in a channel list together with the channel numbers.

### DISCLOSURE OF INVENTION

### Technical Problem

An object of the present invention devised to solve the problem lies on a channel list provision method and apparatus which can output short names corresponding to channel numbers included in a channel list together with the channel numbers, so that the user can easily know additional information regarding a desired channel number before channel changing and thus easily select the desired channel number.

Another object of the present invention devised to solve the problem lies on a channel list provision method and apparatus which can include service type information provided from broadcasting stations in a channel list and provide the resulting channel list, so that the user can conduct a channel selection simply and conveniently with reference to the service type information.

### Technical Solution

The object of the present invention can be achieved by providing a method for providing a channel list in a broadcast receiver, comprising: receiving channel information selected and inputted by a user; searching for channel numbers including the received channel information through a channel manager; configuring the channel list including the searched channel numbers; determining short names corresponding to the searched channel numbers; and including the short names corresponding to the searched channel numbers in the channel list and outputting the resulting channel list to display means.

In another aspect of the present invention, provided herein is an apparatus for providing a channel list in a broadcast receiver, comprising: a user interface for receiving channel info nation selected and inputted by a user; a channel manager for searching for channel numbers including the received channel information and configuring the channel list including the searched channel lumbers; and a channel list provider for determining short names corresponding to the searched channel numbers, including the short names corresponding to the searched channel numbers in the channel list and outputting the resulting channel list to display means.

### ADVANTAGEOUS EFFECTS

According to the present invention, short names corresponding to channel numbers included in a channel list can be outputted together with the channel numbers. Therefore, the user can easily know additional information regarding a desired channel number before channel changing and thus easily select the desired channel number.

In addition, according to the present invention, service type information from broadcasting stations can be provided in a channel list. Therefore, the user can conduct a channel selection simply and conveniently with reference to the service type information.

### BRIEF DESCRIPTION OF THE DRAWINGS

The accompanying drawings, which are included to provide a further understanding of the invention, illustrate embodiments of the invention and together with the description serve to explain the principle of the invention.

In the drawings:

FIG. 1 is a view illustrating a conventional example of configuring a channel list and providing the configured channel list to the user.

FIG. 2 is a flowchart illustrating a process of including short names in a channel list and providing the resulting channel list, according to one embodiment of the present invention.

FIG. 3 is a view illustrating an example of including short names corresponding to channel numbers in a channel list and outputting the resulting channel list, according to the present invention.

FIG. 4 is a flowchart illustrating a process of providing a channel list including service type information, according to an alternative embodiment of the present invention.

FIG. 5 is a view illustrating an example of outputting a channel list in such a manner that service type information of respective channels are distinguished from one another, according to the present invention.

FIG. 6 is a block diagram showing the configuration of a channel list provision apparatus according to one embodiment of the present invention.

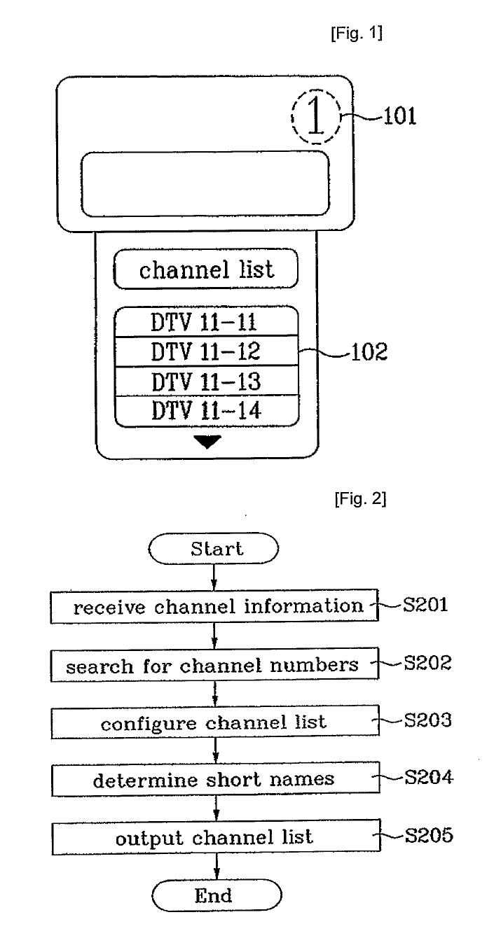

### BEST MODE FOR CARRYING OUT THE INVENTION

Reference will now be made in detail to the preferred embodiments of the present invention, examples of which are illustrated in the accompanying drawings.

FIG. 2 is a flowchart illustrating a process of including short names in a channel list and providing the resulting channel list, according to one embodiment of the present invention.

Referring to FIG. 2, a channel list provision apparatus according to the present embodiment receives channel information selected and inputted by the user at step S201. At this time, the channel list provision apparatus receives the channel information inputted by the user through a remote controller, etc. The channel information may be information about the first digit of a channel number to be selected by the user. For example, the user may input the first digit ‘1’ of a desired channel number as the channel information.

At step S202, the channel list provision apparatus searches for channel lumbers including the received channel information. At this time, the channel number search can be performed by a channel manager.

At step S203, the channel list provision apparatus configures a channel list including the searched channel numbers. The channel list is a set of all channel numbers matched with the channel information inputted by the user.

At step S204, the channel list provision apparatus determines short names corresponding to the searched channel numbers. Each short name is information for identification of a corresponding channel number, which may be, for example, a title of a broadcast program of the corresponding channel number or a digest of the title of the broadcast program when the title is long.

The channel list provision apparatus can determine the short names corresponding to the searched channel numbers with reference to information in a Cable Virtual Channel Table (CVCT) of a Program and System Information Protocol (PSIP).

Alternatively, the channel list provision apparatus may transmit, to a PSIP engine, a query inquiring the short names corresponding to the searched channel numbers, and the PSIP engine may search a certain database for the short names and transmit the search results to the channel list provision apparatus.

At step S205, the channel list provision apparatus includes the short names corresponding to the searched channel numbers in the channel list and outputs the resulting channel list to display means. At this time, each short name can be supported up to a certain data amount, for example, ‘8’ letters.

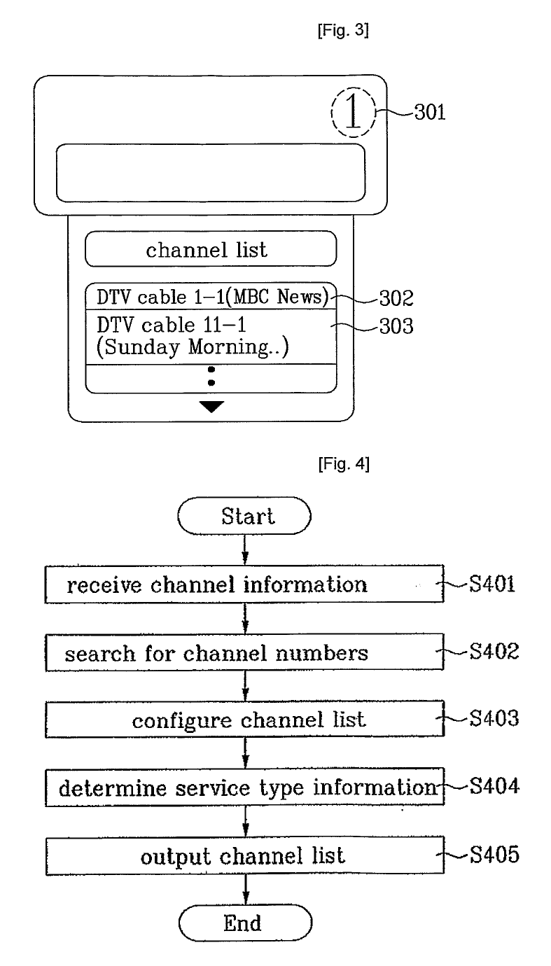

FIG. 3 illustrates an example of including short names corresponding to channel numbers in a channel list and outputting the resulting channel list, according to the present invention. Referring to FIG. 3, a channel list provision apparatus of the present invention searches for channel numbers including channel information 301 inputted by the user, configures a channel list including the searched channel numbers, includes, in the channel list, short names 302 and 303 corresponding respectively to the channel numbers included in the channel list, and outputs the resulting channel list. For example, a short name corresponding to a channel number 1-1 may be outputted as ‘MBC NEWS’ and a short name corresponding to a channel number 11-1 may be outputted as ‘SUNDAY MORNING GARDEN’.

As described above, according to the present invention, short names corresponding to channel numbers included in a channel list can be outputted together with the channel numbers. Therefore, the user can easily know additional information regarding a desired channel number before channel changing and thus easily select the desired channel number.

In other words, because a conventional channel list provides only channel numbers, in order to let the user to know a broadcast program of each channel number, it is necessary to output the broadcast program of each channel number or Electronic Program Guide (EPG) data of each channel number. As a result, it is impossible for the user to rapidly and simply recognize the broadcast program of each channel number. In contrast, according to the present invention, additional information regarding channel numbers is provided in a channel list, so that the user can conduct a channel selection rapidly, simply and conveniently.

On the other hand, in MMS broadcasting, virtual channels of various service types may exist in one physical channel, so there is a need to provide service type information corresponding to each channel number.

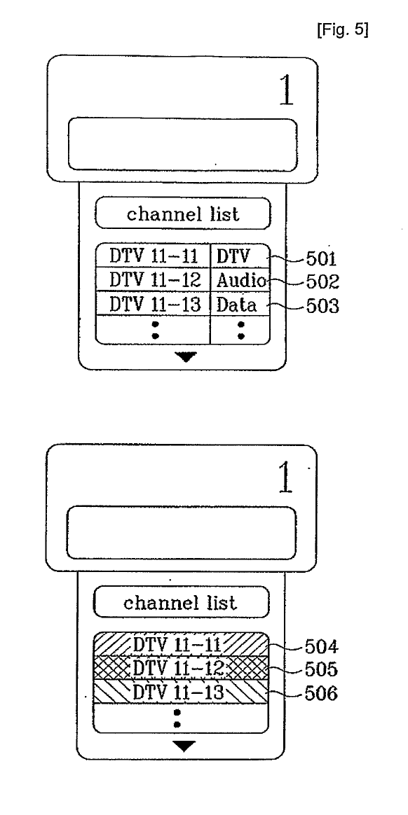

FIG. 4 is a flowchart illustrating a process of providing a channel list including service type information, according to an alternative embodiment of the present invention.

Referring to FIG. 4, a channel list provision apparatus according to the present embodiment receives channel information selected and inputted by the user at step S401. At this time, the channel list provision apparatus receives the channel information inputted by the user through input means such as a remote controller. The channel information may be information about the first digit of a channel number to be selected by the user. For example, the user may input the first digit ‘1’ of a desired channel number as the channel information.

At step S402, the channel list provision apparatus searches for channel numbers including the received channel information. At this time, the channel number search can be performed by a channel manager.

At step S403, the channel list provision apparatus configures a channel list including the searched channel numbers. The channel list is a set of all channel numbers matched with the channel information inputted by the user.

At step S404, the channel list provision apparatus determines service type information corresponding to the searched channel numbers. The service type information refers to classification information based on the types of signals provided from broadcasting stations. For example, the service type information may be information about the types of signals which are received over virtual channels included in one physical channel in MMS broadcasting.

For example, the service type information may be information about the types of signals as follows:

1. Analog television

2. Digital television (ATSC digital television)

3. Audio (ATSC audio)

4. Data (ATSC data only service)

The channel list provision apparatus can transmit, to a Program and System Information Protocol (PSIP) engine, a query inquiring the service type information corresponding to the searched channel numbers to determine the service type information corresponding to the searched channel numbers, and the PSIP engine may search a certain database for the service type information and transmit the search results to the channel list provision apparatus.

At step S405, the channel list provision apparatus includes the service type information corresponding to the searched channel numbers in the channel list and outputs the resulting channel list to display means. At this time, the channel list provision apparatus can output the channel list in such a manner that the service type information of the respective channel numbers are distinguished from one another.

For example, the channel list provision apparatus may output the service type information of the respective channel numbers with different background colors or output respective icons indicating the service type information aside the corresponding channel numbers.

FIG. 5 is a view illustrating an example of outputting a channel list in such a manner that service type information of respective channels are distinguished from one another, according to the present invention.

Referring to FIG. 5, a channel list provision apparatus of the present invention additionally provides, in a channel list, an icon ‘DTV’ 501 indicating a channel providing a digital television signal, an icon ‘AUDIO’ 502 indicating a channel providing an audio signal, and an icon ‘DATA’ 503 indicating a channel providing a data signal such that service type information of the respective channels are distinguished from one another.

Alternatively, the channel list provision apparatus may output the service type information of the respective channel numbers with different background colors 504, 505 and 506 such that the service type information of the respective channels are distinguished from one another.

As described above, according to the present invention, service type information from broadcasting stations can be provided in a channel list. Therefore, the user can conduct a channel selection simply and conveniently with reference to the service type information.

For example, different broadcast signals may be transmitted over a plurality of virtual channels included in one physical channel. In the present invention, the user can conduct a channel selection by seeing such broadcast signals in the channel list at a glance.

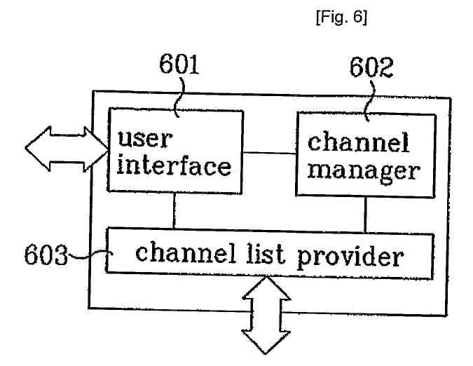

FIG. 6 is a block diagram showing the configuration of a channel list provision apparatus according to one embodiment of the present invention. Referring to FIG. 6, the channel list provision apparatus according to the present embodiment includes a user interface 601, channel manager 602, and channel list provider 603.

The user interface 601 receives channel information selected and inputted by the user.

The channel manager 602 searches for channel numbers including the received channel information and configures a channel list including the searched channel numbers.

The channel list provider 603 determines short names corresponding to the searched channel numbers, includes the short names corresponding to the searched channel numbers in the channel list and outputs the resulting channel list. As stated previously, each short name may be a title of a broadcast program of the corresponding channel number.

The channel list provider 603 can determines the short names with reference to a CVCT of a PSIP. Alternatively, the channel list provider 603 may transmit, to a PSIP engine, a query inquiring the short names corresponding to the searched channel numbers, and the PSIP engine may search the CVCT for the short names and transmit the search results to the channel list provider 603.

A channel list provision apparatus according to an alternative embodiment of the present invention may include a user interface 601, channel manager 602, and channel list provider 603.

The user interface 601 receives channel information selected and inputted by the user.

The channel manager 602 searches for channel numbers including the received channel information and configures a channel list including the searched channel numbers.

The channel list provider 603 determines service type information corresponding to the searched channel numbers, includes the service type information corresponding to the searched channel numbers in the channel list and outputs the resulting channel list. As stated previously, the service type information may be information about at least one of analog television signal, digital television signal, audio signal and data signal service types.

The channel list provider 603 can transmit, to a PSIP engine, a query inquiring the service type information corresponding to the searched channel numbers, and the PSIP engine may search a database for the service type information corresponding to the channel numbers and transmit the search results to the channel list provider 603.

Because the channel list provision apparatus according to the present invention has been described and the technical contents described in the above embodiments are also applicable to the channel list provision apparatus of FIG. 6 as they are, a detailed description of the channel list provision apparatus of FIG. 6 will be omitted.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### MODE FOR THE INVENTION

Various embodiments have been described in the best mode for carrying out the invention.

### INDUSTRIAL APPLICABILITY

As apparent from the above description, according to the present invention, short names or service type information corresponding to channel numbers included in a channel list can be outputted together with the channel numbers. Therefore, the user can easily know additional information regarding a desired channel number before channel changing and thus easily select the desired channel number.

1. A method for providing a channel list in a broadcast receiver, comprising:
receiving channel information selected and inputted by a user;
searching for channel numbers including the received channel information through a channel manager;
configuring the channel list including the searched channel numbers;
determining short names corresponding to the searched channel numbers; and
including the short names corresponding to the searched channel numbers in the channel list and outputting the resulting channel list to display means.

2. The method according to claim 1, wherein each of the short names is a title of a broadcast program of a corresponding one of the channel numbers or a digest of the title of the broadcast program.

3. The method according to claim 1, wherein the step of determining the short names comprises determining the short names with reference to a Cable Virtual Channel Table (CVCT) of a Program and System Information Protocol (PSIP).

4. The method according to claim 1, wherein the step of determining the short names comprises a PSIP engine searching a database for the short names corresponding to the searched channel numbers.

5. A method for providing a channel list in a broadcast receiver, comprising:
receiving channel information selected and inputted by a user;
searching for channel numbers including the received channel information;
configuring the channel list including the searched channel numbers;
determining service type information corresponding to the searched channel numbers; and
including the service type information corresponding to the searched channel numbers in the channel list and outputting the resulting channel list to display means.

6. The method according to claim 5, wherein the service type information is information about at least one of analog television signal, digital television signal, audio signal and data signal service types.

7. The method according to claim 5, wherein the step of determining the service type information corresponding to the searched channel numbers comprises a PSIP engine searching a database for the service type information corresponding to the searched channel numbers.

8. An apparatus for providing a channel list in a broadcast receiver, comprising:
a user interface for receiving channel information selected and inputted by a user;
a channel manager for searching for channel numbers including the received channel information and configuring the channel list including the searched channel numbers; and
a channel list provider for determining short names corresponding to the searched channel numbers, including the short names corresponding to the searched channel numbers in the channel list and outputting the resulting channel list to display means.

9. The apparatus according to claim 8, wherein each of the short names is a title of a broadcast program of a corresponding one of the channel numbers or a digest of the title of the broadcast program.

10. The apparatus according to claim 8, wherein the channel list provider determines the short names with reference to a CVCT of a PSIP.

11. The apparatus according to claim 8, wherein the channel list provider determines the short names with reference to search results obtained by searching a database for the short names corresponding to the searched channel numbers by a PSIP engine.

12. An apparatus for providing a channel list in a broadcast receiver, comprising:
a user interface for receiving channel information selected and inputted by a user;
a channel manager for searching for channel numbers including the received channel information and configuring the channel list including the searched channel numbers; and
a channel list provider for determining service type information corresponding to the searched channel numbers, including the service type information corresponding to the searched channel numbers in the channel list and outputting the resulting channel list to display means.

13. The apparatus according to claim 12, wherein the service type information is information about at least one of analog television signal, digital television signal, audio signal and data signal service types.

14. The apparatus according to claim 12, wherein the channel list provider determines the service type information with reference to search results obtained by searching a database for the service type information corresponding to the searched channel lumbers by a PSIP engine.
